(19) United States
(12) Patent Application Publication
(10) Pub. No.: US 2005/0144156 A1
(43) Pub. Date: Jun. 30, 2005

(54) System and method for vehicle identification

(75) Inventor: Jason Ronald Barber, Kallaroo (AU)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(73) Assignee: SUPERSOFTWARE INTERNATIONAL PTY LTD, Bentley, Perth (AU)

(21) Appl. No.: 10/489,506

(22) PCT Filed: Sep. 12, 2002
(86) PCT No.: PCT/AU02/01248

(30) Foreign Application Priority Data
Sep. 12, 2001 (AU) PR 7634

(51) Int. Cl. G06F 7/00

(52) U.S. Cl. 707/3

(57) ABSTRACT

A system for vehicle identification comprising: a storage means for storing details on a multiplicity of vehicles and details of a multiplicity of characteristics associated with and available for, the vehicles; selection means operable to allow a user of the system to select details of a vehicle and one or more of the associated and available characteristics; and processing means, operable in response to the selection chosen by the user using the selection means, to generate a three-dimensional representation of the selected vehicle incorporating the selected characteristics.

### FIELD OF THE INVENTION

The present invention relates to a system and method for vehicle identification, particularly, although not exclusively, for use by crime investigation authorities to identify vehicles used in crimes.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background to the invention is intended to facilitate an understanding of the present invention. However, it should be appreciated that the discussion is not an acknowledgement or admission that any of the material referred to was published, known or part of the common general knowledge in Australia as at the priority date of the application.

Memory recall can be highly variable, and very often inaccurate. This is particularly so, when witnesses to crimes are asked to describe the incident that they have witnessed and particularly details of people and things associated with any such incident. The likelihood of a witness providing an accurate description may vary depending upon a variety of factors. Where a witness has been asked to recall details of vehicles involved in incidents, information can be limited to the colour of the vehicle, or even highly generic descriptions—such as it being a four-wheel drive, or simply a truck. This makes it very difficult to provide a description that is sufficiently robust to allow an investigation to proceed.

### DISCLOSURE OF THE INVENTION

According to the present invention, there is provided a system for vehicle identification comprising:
a storage means for storing details on a multiplicity of vehicles and details of a multiplicity of characteristics associated with and available for, the vehicles;
selection means operable to allow a user of the system to select details of a vehicle and one or more of the associated and available characteristics stored in the storage means; and
generating means, operable in response to the selection chosen by the user using the selection means, to generate a representation of the selected vehicle incorporating the selected characteristics.

Preferably, the representation generated is a three-dimensional representation of the selected vehicle incorporating the selected characteristics.

Preferably, the vehicles may be selected from all available vehicle makes available for sale or manufactured in a predetermined jurisdiction over a predetermined period of time.

Preferably, search means is provided to allow the user to enter in predetermined data relating to the vehicle to be identified, the search means operable to create a list of vehicles and the one or more of the associated and available characteristics stored in the storage means that satisfies the predetermined data and the selection means operable to allow a user of the system to select details of a vehicle and one or more of the associated and available characteristics from the list of vehicles.

Preferably, the characteristics associated with and available for each vehicle includes colour, wheel type, bullbar type, headlight style, taillight style, antenna type, badging, body striping, rusting style, bonnet scoop, spoiler type, dent effects and lettering style.

Preferably, means is provided such that the user can allocate a confidence level to the vehicle selection and/or one or more of the associated and available characteristics, the confidence level representing the level of certainty the user has that the three-dimensional representation generated by the processing means conforms with a witness' recollection of a vehicle to be identified or a characteristic of the vehicle to be identified.

More preferably, the confidence level is expressed as a percentage value.

Alternatively, the confidence level is expressed as one of the set of following descriptors: Unsure, Non-committal, Fairly sure, Definite stake.

Preferably, display means is provided to display the representation of the vehicle.

More preferably, the displayed representation of the vehicle is able to be manipulated such that substantially all aspects of the vehicle are able to be viewed by the user via the display means.

More preferably, means is provided to superimpose the representation of the vehicle on a picture.

According to another aspect of the present invention, there is provided a method for vehicle identification comprising:
selecting details of a vehicle and one or more associated and available characteristics from a storage means for storing details on a multiplicity of vehicles and details of a multiplicity of characteristics associated with and available for the vehicles; and
generating a representation of the selected vehicle incorporating the selected characteristics.

Preferably, the representation generated is a three-dimensional representation of the selected vehicle incorporating the selected characteristics.

Preferably, the method includes the step of allocating a confidence level to the vehicle selection and/or one or more of the associated and available characteristics.

Preferably, the method includes the step of displaying the representation of the selected vehicle.

More preferably, the method includes the step of manipulating the displayed representation of the selected vehicle, such that substantially all aspects of the vehicle are able to be viewed by the user.

More preferably, the method includes the step of superimposing the representation of the vehicle on a picture.

According to yet a further aspect of the invention there is provided a method for vehicle identification comprising:
entering predetermined data associated with the vehicle to be identified;
generating a list of vehicles and details of a multiplicity of characteristics associated with and available for the vehicles that satisfies the predetermined data stored in a storage means for storing details on a multiplicity of vehicles and details of a multiplicity of characteristics associated with and available for, the vehicles;
selecting details of a vehicle and one or more associated and available characteristics from the storage means; and
generating a representation of the selected vehicle incorporating the selected characteristics.

In this manner, the present invention has the advantage of providing a means of being able to systematically generate representations of vehicles that truly represent the vehicles available in the market, and therefore likely to be more accurate. It also allows witnesses to more effectively recall details of vehicles that they may have witnessed.

### BRIEF DESCRIPTION OF THE DRAWINGS

The invention will now be described, by way of example only, with reference to the accompanying drawings, of which:

FIG. 1 is a schematic representation of an embodiment of a system incorporating the present invention;

FIG. 2 is an entity diagram of a vehicle library used in an embodiment of the present invention;

FIG. 3 is an entity diagram of vehicle library attributes used in an embodiment of the present invention;

FIG. 4 is an entity diagram of vehicle library customisation options as used in an embodiment of the present invention;

FIGS. 5A and 5B are entity diagrams of session data as used in an embodiment of the present invention;

FIG. 6 is an entity diagram of framework architecture of the system of an embodiment of the present invention;

FIG. 7 is an entity diagram of a main frame of the framework architecture of an embodiment of the system of the present invention; and

FIG. 8 is an entity diagram of a Work Area View of the framework architecture of an embodiment of the system of the present invention.

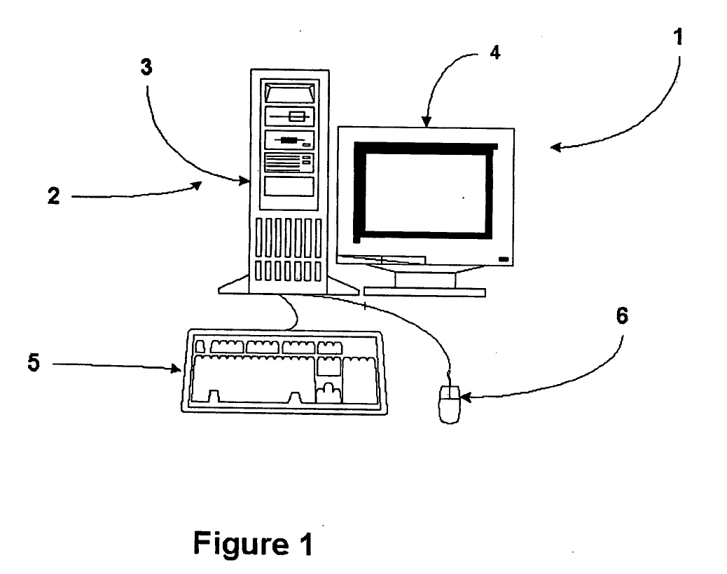

### BEST MODE(S) FOR CARRYING OUT THE INVENTION

The system 1 of the present invention comprises a computer 2—such as a personal computer—and includes (as is well known to a person skilled in the art), a processing unit 3, a display 4, a keyboard 5, and a mouse 6. As is also well known, the processing unit 3 includes an appropriate processor and memories—including a database—as well as other circuitry (not shown). In so far as it is not relevant to the present invention, and is well known, the form and operation of the computer need not be described in any further detail herein.

In the embodiment described herein, the computer 2 is operable to run a software application—as will be described in more detail below—on a Windows™—based operating system.

At a user/operator level, the system 1 enables a user—on the basis of information supplied by a witness—to draw up a detailed three-dimensional representation of a vehicle.

An instance of vehicle identification—hereinafter referred to as a session—begins by the user of the system 1 (typically a police officer) registering initial details such as name, rank, location of session, incident date and time, and any other appropriate details such as witness details, incident or crime details and the recollections of the witness in their own words.

The witness is then prompted to select information that is known about the vehicle to be identified from drop down lists. For example, if the witness identifies the vehicle by the vehicle manufacturer and it's colour, then the system is operable to display all vehicles available from that manufacturer, in that colour. The witness can then select from the vehicles displayed the one that most closely matches the one that the witness recalls seeing. The vehicle models displayed will vary depending upon the information supplied by the witness. For example, if the witness identifies the vehicle as a yellow four-wheel drive vehicle, then the system will be operable to display all four-wheel drive vehicles available on the market—whatever the vehicle manufacturer. Once the witness is happy with the basic appearance of the vehicle, then the witness is then able to customise the vehicle further—for example, by adding available accessories such as bullbars, spoilers, alloy wheels, as well as adding features such as those relating to the wear of the vehicle—such as rusting, and minor dents. The available customisation for the selected vehicle will depend upon the vehicle selected. So, for example, it will only be possible to colour the vehicle in those colours, and finishes, available for that particular make and model.

In further embodiments of the invention, the available customisation for the selected vehicle may not depend upon the vehicle selected, for identification in the case where the vehicle has been unconventionally modified by an owner subsequent to purchase. So, for example, in further embodiments it may be possible to colour the vehicle in colours, and finishes, not typically available for that particular make and model.

The user can build up a detailed representation of the vehicle from any basis—but it would usually be on the basis of characteristics such as colour, basic body shape, or something more detailed such as manufacturer and model, if possible. At each stage of the process the available options available for selection are displayed on the display 4 as image(s). The image(s) can be selected, and manoeuvred by means of the mouse 6 and/or keyboard in the usual manner.

Once the customisation is complete, then the three-dimensional representation as seen on the display 4 can be printed as a hard copy, or saved as a data file on the system, for example, for sending as an email attachment.

The system 1 includes graphics software that allows the representation to be provided as a three-dimensional representation, which can be rotated so that the witness can view the representation from an angle corresponding to the witness' view of the incident. The graphics can also render the image to provide a “life-like” appearance to the representation.

In the embodiment, the three-dimensional representation of the vehicle may be superimposed on a picture of the incident taken from where the witness' observed the incident, to aid the memory of the witness.

The software application of the present invention, and which is used for vehicle identification, will, in this embodiment, be written in Visual C++, using appropriate software. The graphical user interface (GUI) will be provided using Microsoft Foundation Classes (MFC) and will also include a three-dimensional graphics package incorporating graphics rendering, such as the commercially available “Lightworks”™ software. The software application also incorporates appropriate database management software.

In the present embodiment the database is a relational database, and can be used to store sets of data relating to the following:
Vehicle Model Data
Session Data

It will be understood that although in the embodiment described herein the two sets of data are taken to be stored in a single database, they can also be stored in separate databases and may, on occasions in this specification, be referred to as such.

The Vehicle Model Data comprises three-dimensional representations of vehicle models of vehicles on the market, and is stored as read-only data.

The Session data is data relating to a particular session. Session data includes such information as that relating to the crime incident, as well as three-dimensional representations of customised vehicle generated during a session.

The database management software includes database independent persistence that will abstract all data management creation, retrieval, update, and deletion (CRUD) operations. The vehicle model consists of a Vehicle Library and Vehicle Accessories Library, while the session data consists of Session Information and Customised Vehicles.

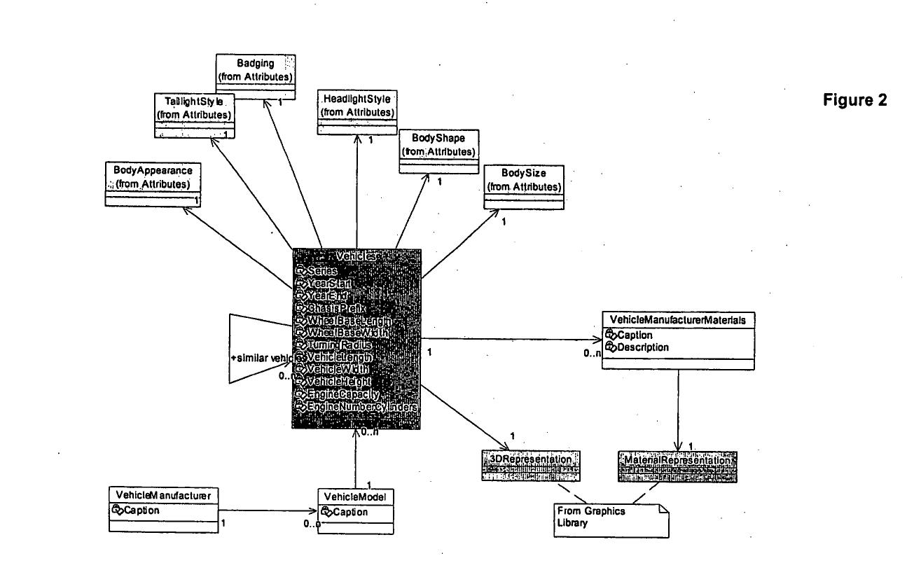

Vehicle Library—See FIG. 2.

At the highest level the Vehicle Library consists of the following Entities:
Vehicle Manufacturer
Vehicle Models
Vehicle Series
Similar Vehicle's
Vehicle Manufacture Materials
Body Shape Categories
Body Size Categories
Body Appearance Categories
Headlight Style Categories
Taillight Style Categories
Badging Categories
Wheel Type Templates
Antenna Type Templates
Background/Props Templates
Bullbar Templates
Rusting Style Templates
Lettering Style Templates
Pin striping Templates
Badging/Graphic Templates
Rear Spoiler Templates
Bonnet Scoop Templates
Dent effect Templates
   Vehicle Manufacturer

A vehicle Manufacturer represents a Vehicle manufacturer. It has the following Attributes:
ID—used internally
Caption—human readable and searchable string
   Vehicle Model/Series

A vehicle Model represents a Vehicle from the manufacturer. It has the following Attributes:
ID—used internally
Caption—human readable and searchable string
3D Representation—may be specific to Lightworks SDK
Body (ID)—reference to instance of Body Shape Object
Vehicle Size (ID)—reference to instance of Vehicle Size Object
Start Year—First Year of manufacture
End Year—Last Year of Manufacture
Body Appearance (ID)—reference to instance of Body Appearance Object
Headlight Style (ID)—reference to instance of Headlight Style Object
Taillight Style (ID)—reference to instance of Taillight Style Object
Chassis (Vehicle Identification Number) Prefix
Wheel Base Length
Wheel Base Width
Turn Radius
Vehicle Length
Vehicle Width
Vehicle Height
Engine Capacity
Engine Number Cylinders
Similar Vehicles ID—reference to instance of Similar Vehicles Object
   Similar Vehicles

Similar Vehicles are used to categorise vehicles that are similar. It has the following Attributes:
ID—used internally
   Vehicle Manufacture Materials

Vehicle Manufacture Materials are used to categorise materials that a particular model/series is available in. It has the following Attributes:

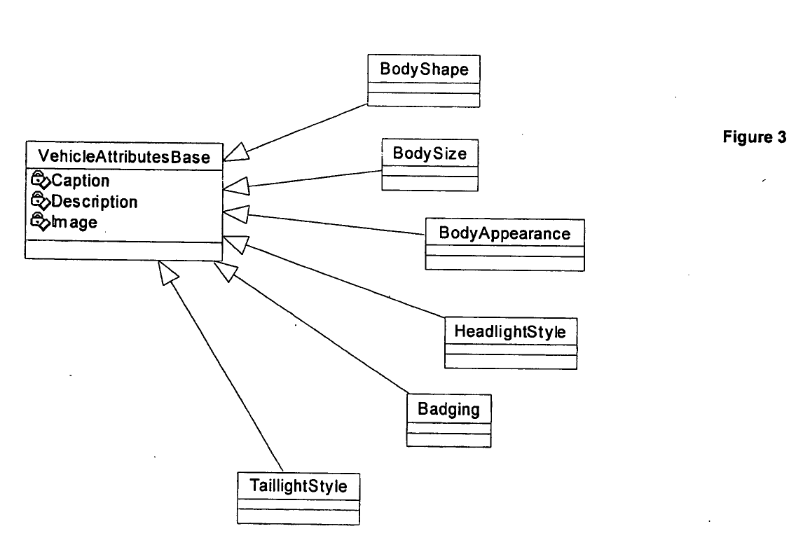

ID—used internally
Caption—human readable and searchable string
Description—More detailed information about the object
Material Information—may be specific to Lightworks SDK
   Vehicle Library Attributes used in Visual Searches—See FIG. 3.

Vehicle Attribute Categories are used to categorise Vehicles. Visual Search criteria are used to query cars matching these attributes. Instances of this class will not be instantiated. It is purely defined as common attributes as a base class to allow specialisation. It has the following (generic) Attributes:
ID—used internally
Caption—human readable and searchable string
Description—More detailed information about the object
Image—2D representation of the object

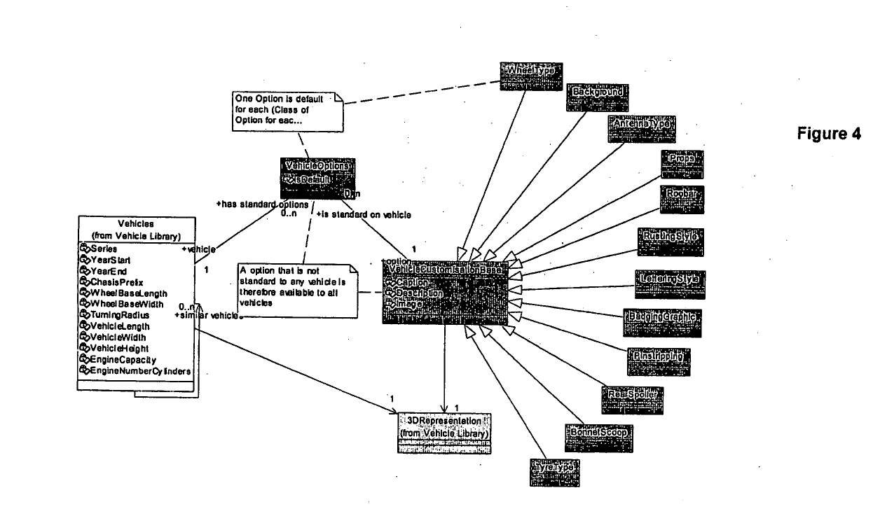

The following Entities will be specialisations of this class:
Body Shape Categories
Body Size Categories
Body Appearance Categories
Headlight Style Categories
Taillight Style Categories
Badging Categories
   Vehicle Library Customisation Options—See FIG. 4.

Vehicle Customisation Templates are used to customise attributes of a Customised Vehicle. Instances of this class will not be instantiated. It is purely defined as common attributes as a base class to allow specialisation. It has the following (generic) Attributes:
ID—used internally
Caption—human readable and searchable string
Description—More detailed information about the object
Image—2D representation of the object
3D Representation—may be specific to Lightworks SDK

The following Entities will be specialisations of this class:
Wheel Type Templates
Antenna Type Templates
Background Templates
Props Templates
Bullbar Templates
Rusting Style Templates
Lettering Style Templates
Pin striping Templates
Badging/Graphic Templates
Rear Spoiler Templates
Bonnet Scoop Templates
Dent Effect Templates

These items allow a user to build a representation of a vehicle during a session.

The second set of data is the session data that includes data for a specific session.

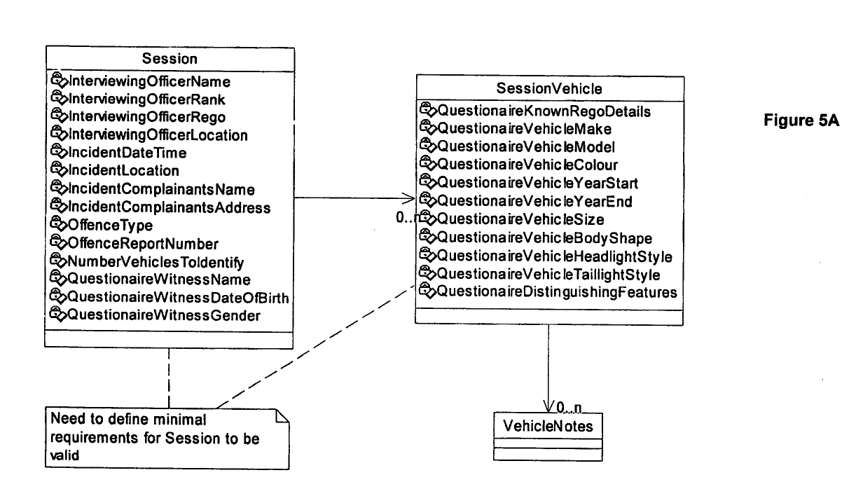

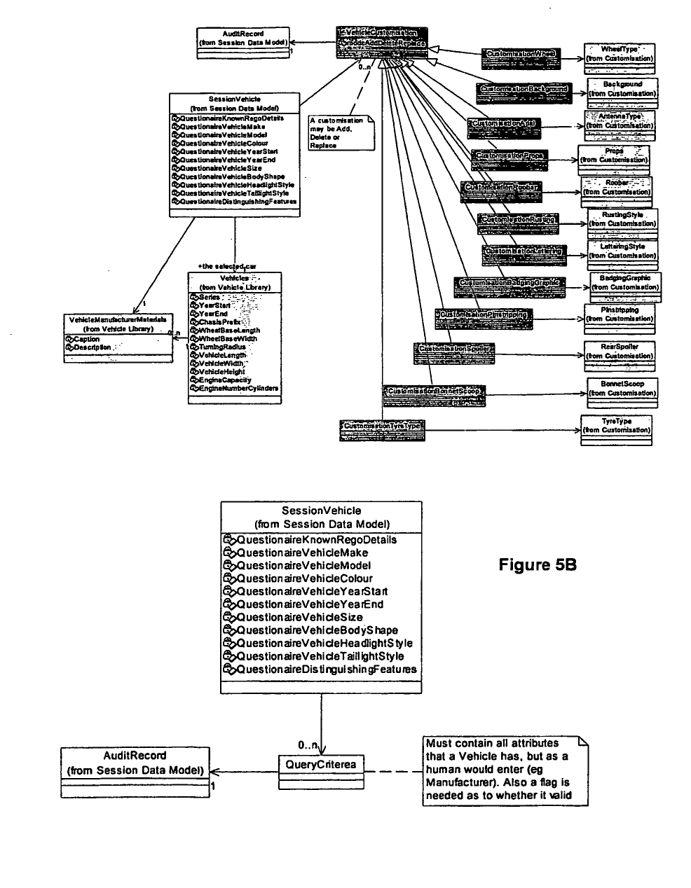

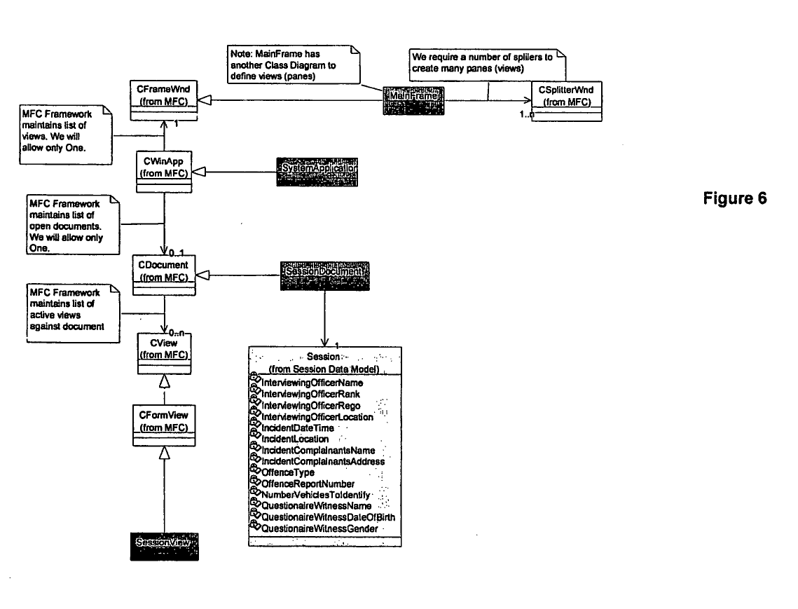

At the highest level the Vehicle Library consists of the following Entities—see FIG. 5:
Session
Session Vehicle (Questionnaire about each car and Customisation details)
Audit History—see FIG. 6.

As mentioned above, a session represents a single use of the system 1. It has the following Attributes:
ID—used internally
Interviewing Officer Name
Interviewing Officer Rank
Interviewing Officer Number
Interviewing Officer Location
Incident Date Time
Incident Location
Incident Complainants Name
Incident Complainants Address
Offence Type
Offence Report Number
Number of Vehicles to Identify
Witness Name
Witness Date of Birth
Witness Gender
   Session Vehicle

A Session Vehicle represents a customisation of a vehicle within a session. It has the following Attributes:
ID—used internally
Questionnaire Known Vehicle Registration Number Details—The registration number of the vehicle as provided by the witness. Details captures the vehicle registration number if known.
Questionnaire Vehicle Manufacturer
Questionnaire Vehicle Model
Questionnaire Vehicle Colour
Questionnaire Vehicle Year Start
Questionnaire Vehicle Year End
Questionnaire Vehicle Size
Questionnaire Vehicle Body Shape
Questionnaire Vehicle Headlight Style
Questionnaire Vehicle Taillight Style
Questionnaire Vehicle Distinguishing Features

With regard to the user interface, Microsoft Foundation Classes (MFC) provides the framework for the Graphical User Interface (GUI) library. The Document/View architecture from MFC is used as the basis for the GUI. A document will contain an instance of a Session Object from the Session data and a constant reference to the Vehicle Library Object from the vehicle model data. The following user interface elements are used:

Controls

Committal Factor Control—that is the extent to which the witness is sure of his information. Committal Factor Control enables the user to allocate a confidence level to a session vehicle. The confidence level represents the level of certainty the user has that the session vehicle conforms with the recollection that a witness has of the vehicle to be identified or a characteristic of the vehicle to be identified and is expressed as one of the set of following descriptors: Unsure; Non-committal; Fairly Sure; Definite Stake. In an alternative embodiment of the invention, the confidence level can be expressed as a percentage.
Vehicle Thumbnail Control (with candidacy status)—A pop-up control box that lets the user select a vehicle or see information about the vehicle. Vehicle Thumbnail Control enables the user to select a list of options using a “right mouse click”, the options allowing the user to select a vehicle for further consideration, de-select or remove the vehicle from further consideration, show the vehicle in a “pop-up” window, or show statistical details on the vehicle.
Visual Selection List Control (Image, Caption, Tool Tips)—This enables a user to display a list of images and allows the user to select between them. This is the list of vehicles the user has selected to view.
Vehicle 3D Canvas
   Dialogs
Splash—i.e. the first window/screen to display when the application is initialised
System Tutorial
About Box
Case Manager (A view to manage all Session Objects In the Database)
3D Vehicle Details (A view displaying statistical data on a selected vehicle from the current session)
   Views
Navigation Tree (GUI controller)—used by Questionnaire, Vehicle Search, Display Configuration, Forensic Search, Vehicle Details, Vehicle Candidates, Vehicle Summary, Vehicle Customisation, and Similar Vehicles.
Customise Tools Tree (GUI controller) that comprises a list of folders and sub-folders containing the accessories and materials, such as boots, and windows, that can be applied to a vehicle representation to customise the vehicle representation.
Helpful Comments—also used by Questionnaire, Vehicle Search, Display Configuration, Forensic Search, Vehicle Details, Vehicle Candidates, Vehicle Summary, Vehicle Customisation, and Similar Vehicles. Helpful Comments includes text which explains to the user how to complete details on the system. In the present embodiment, Helpful Comments may include “Hatch is a vehicle with a rear door which opens upwards”.
Notes Area—also used by Questionnaire, Vehicle Search, Display Configuration, Forensic Search, Vehicle Details, Vehicle Candidates, Vehicle Summary, Vehicle Customisation, and Similar Vehicles. This is a “Help” screen to assist the user in completing the view.
Search Criteria Comparison—used by, Vehicle Candidates, Similar Vehicles, Vehicle Summary, and Vehicle Customisation, when navigated by Visual or Forensic Search. In this view, all vehicles are displayed that match the description provided by the witness. In the present embodiment, if the user selected a 2 door hatch as the description of a vehicle, the Search Criteria Comparison is the list of all 2 door hatch vehicles on the database.
Video Presentation provides an animation sequence of about 15 seconds duration showing 3D car models and actual police footage—for marketing purposes.
Login
Main Icon
Display Configuration
Questionnaire Wizard—provides questionnaires that allow the user to input detail for the session
   Interviewing Officer Page
   Incident Details Page
   Witness Details Page
   Vehicle Details Page
   Summary Page
Visual Search Wizard (including Committal Factor)—these guide witnesses through the selection process
   Manufacturer Page
   Model Page
   Year Page
   Body Shape Page
   Vehicle Size Page
   Vehicle Appearance Page
   Vehicle Badging Page
   Headlight Style Page
   Taillight Style Page
Advanced Search—this combines the visual search wizard with the forensic search (see below). For example, in the present embodiment, Advanced Search may be a combination of the visual search wizard describing what a witness saw, such as a small 4 door sedan, and forensic search values describing forensic evidence obtained at a crime scene, such as a vehicle track width of 1450 mm.
Forensic Search—this is a search based purely on forensic or statistical values, such as, for example, wheel track width or the height of the vehicle. Forensic Search enables searching based on forensic or statistical values including, in the present embodiment, vehicle data such as overall vehicle length, vehicle height, vehicle engine capacity.
Search Results Wizard
   Matching Vehicles Page (including candidate status)
   Selected Vehicles Page
   Similar Vehicles Page (including candidate status)
   The Vehicle Page
Customise Vehicle
Report

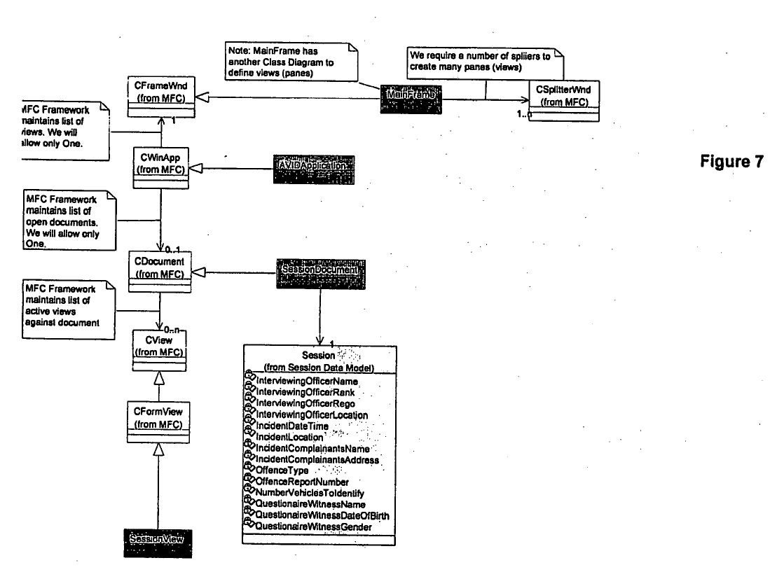

The following framework classes are used—see FIG. 7.:
SystemApplication derived from CWinApp
MainFrame derived from CFrameWnd
SessionDocument derived from CDocument
SessionView derived from CFormView

Additionally, the frames include docking/splitter panes (views) to the left and a “Work Area” (pane) to the right, an additional class WorkAreaView is derived from SessionView. All Work Area views are derived from this and other views derived from SessionView.

The classes are defined and illustrated in FIG. 7, along with their responsibilities.

Class SystemApplication

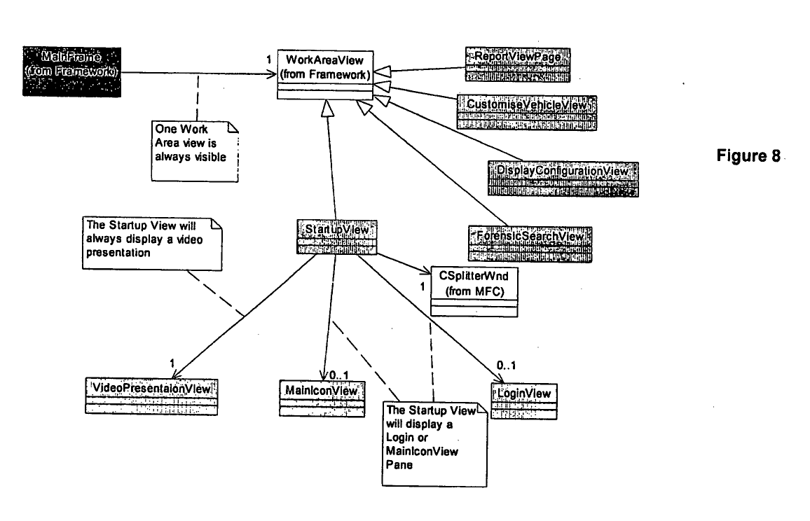

This class will have the following responsibilities:
Set up MFC framework (in particular register Documents and Views).
Initialise Third Party Libraries/packages.
Initialise any additional packages/sub-systems.
   Class MainFrame—See FIG. 8

This class will have the following responsibilities:
GUI Controller creating initial Layout.
GUI Controller creating/destroying (i.e. swapping) Work Area Panes (views).
   Class SessionDocument

This class will have the following responsibilities:
Maintaining an instance of a “Session” object from the Session Data.
Ability to notify views of Data Changes through MFC Framework.
   Class SessionView

This class will have the following responsibilities:
Base class for all Views (panes in the application).
Receive notifications of Document changes through MFC Framework. Derived classes may override this.
   Class WorkAreaView—See FIG. 9.

This class will have the following responsibilities:
Abstract Work Area Panes (views) common controls such as Next (Forward), Previous (Back), and Main Screen buttons.
Abstract Work Area Panes (views) self-validation. I.e. trying to navigate out of this pane (view) to another will invoke validation on the Current Work Area.

A number of session or use case scenarios will now be described. As will be understood to a person skilled in the art, the application is not limited to these use cases—these being discussed for illustrative purposes.
The use case begins when the user selects the Vehicle Search button on the Main Screen
   The MFC Framework maps the command to the MainIconView
      The MainIconView through the SessionDocument notifies the MainFrame of an “Invoke Vehicle Search” request
         The MainFrame destroys the StartupView
         The MainFrame creates the uestionnaireInterviewingOfficerPage
The use case ends
The use case begins when the user selects the Next button on the QuestionnaireInterviewingOfficerPage Screen
The MFC Framework maps the command to the QuestionnaireInterviewingOfficerPage
   The QuestionnaireInterviewingOfficerPage validates the Screen Data
   The QuestionnaireInterviewingOfficerPage through the SessionDocument notifies the MainFrame of a “Move to Witness Details Page” request
      The MainFrame—destroys the QuestionnaireInterviewingOfficerPage
      The MainFrame creates the QuestionnaireWitnessDetailsPage Page
The use case ends
The use case begins when the user selects the “Select” button on the “Vehicle 3D Display” Screen (with the SearchResultsMatchingVehiclesPage Screen behind.)
The MFC Framework maps the command to the Vehicle3DDialog dialog
The Vehicle3DDialog updates the Car status in the SessionDocument
   The SessionDocument notifies MFC Framework of a Modified Document.
      The MFC Framework notifies all Views of a Document Change
         The SearchResultsMatchingVehiclesPage received a “Document Change” notification
            The SearchResultsMatchingVehiclesPage determines if the (particular) Car is displayed in a thumbnail view
            The SearchResultsMatchingVehiclesPage refreshes the VehicleThumbNail control

The use case ends.

From the above, discussion, therefore, it can be seen that the present invention therefore provides a system which allows a user to generate a three-dimensional representation of a vehicle from the starting point of one or more basic criteria, such as the vehicle manufacturer. The user is then provided with three-dimensional representations from a selection that matches such basic criteria. The user can then select the image that most closely represents the vehicle that the user requires i.e. to generate a basic three-dimensional representation. The user then builds on that basic representation to provide a customised representation, with appropriate accessories, colours etc. The user is also able to select and de-select features (including basic representations) until a “best” match is generated. This is all done by displaying information in windows or views on a display of a computer, the information being selected (or deselected) through appropriate mouse or keyboard control.

In an alternative embodiment of the invention, rather than producing a three-dimensional representation of the vehicle to be identified, the system can generate a series of two-dimensional representations that combined form a profile of the vehicle to be identified. For instance, the two-dimensional representations may be of the front, rear, side and top of the vehicle to be identified.

It will be obvious to the person skilled in the art that modifications are possible within the scope of the present invention. For example, the invention is described within the context of an application developed using C++. However, other programming languages and integral software could be used.

1. A system for vehicle identification comprising:
a storage means for storing details on a multiplicity of vehicles and details of a multiplicity of characteristics associated with and available for, the vehicles;
selection means operable to allow a user of the system to select details of a vehicle and one or more of the associated and available characteristics stored in the storage means; and
generating means, operable in response to the selection chosen by the user using the selection means, to generate a representation of the selected vehicle incorporating the selected characteristics.

2. A system for vehicle identification according to claim 1, where the generated representation is a three-dimensional representation of the selected vehicle incorporating the selected characteristics.

3. A system for vehicle identification according to claim 1, where the vehicle may be selected from all available vehicle makes available for sale or manufactured in a predetermined jurisdiction over a predetermined period of time.

4. A system for vehicle identification according to claim 1, where search means is provided to allow the user to enter in predetermined data relating to the vehicle to be identified, the search means operable to create a list of vehicles and the one or more of the associated and available characteristics stored in the storage means that satisfies the predetermined data and the selection means operable to allow a user of the system to select details of a vehicle and one or more of the associated and available characteristics from the list of vehicles.

5. A system for vehicle identification according to claim 1 where the characteristics associated with and available for each vehicle includes color, wheel type, bullbar type, headlight style, taillight style, antenna type, badging, body striping, rusting style, bonnet scoop, spoiler type, dent effects and lettering style.

6. A system for vehicle identification according to claim 1, where means is provided such that the user can allocate a confidence level to the vehicle selection and/or one or more of the associated and available characteristics, the confidence level representing the level of certainty the user has that the representation generated by the processing means conforms with a witness' recollection of the vehicle to be identified or a characteristic of the vehicle to be identified.

7. A system for vehicle identification according to claim 6, where the confidence level is expressed as a percentage value.

8. A system for vehicle identification according to claim 6, where the confidence level is expressed in a non-mathematical form

9. A system for vehicle identification according to claim 1, where display means is provided to display the representation of the vehicle.

10. A system for vehicle identification according to claim 9, where the displayed representation of the vehicle is able to be manipulated such that substantially all aspects of the vehicle are able to be viewed by the user via the display means.

11. A system for vehicle identification according to claim 9, where means is provided to superimpose the representation of the vehicle on a picture.

12. A method for vehicle identification comprising:
selecting details of a vehicle and one or more associated and available characteristics from a storage means for storing details on a multiplicity of vehicles and details of a multiplicity of characteristics associated with and available for, the vehicles; and
generating a representation of the selected vehicle incorporating the selected characteristics.

13. A method for vehicle identification comprising:
entering predetermined data associated with the vehicle to be identified;
generating a list of vehicles and details of a multiplicity of characteristics associated with and available for the vehicles that satisfies the predetermined data stored in a storage means for storing details on a multiplicity of vehicles and details of a multiplicity of characteristics associated with and available for, the vehicles;
selecting details of a vehicle and one or more associated and available characteristics from the storage means; and
generating a representation of the selected vehicle incorporating the selected characteristics.

14. A method of vehicle identification according to claim 11, where the step of generating a representation of the selected vehicle incorporating the selected characteristics generates a three-dimensional representation of the selected vehicle incorporating the selected characteristics.

15. A method for vehicle identification according to claim 12 including the step of allocating a confidence level to the vehicle selection and/or one or more of the associated and available characteristics.

16. A method for vehicle identification according to claim 12 including the step of displaying the three-dimensional representation of the selected vehicle.

17. A method for vehicle identification according to claim 16, including the step of manipulating the displayed three-dimensional representation of the selected vehicle, such that substantially all aspects of the vehicle are able to be viewed by the user.

18. A method for vehicle identification according to claim 16, including the step of superimposing the three-dimensional representation of the vehicle on a picture.

19. (canceled)
